(19) United States
(12) Patent Application Publication
(10) Pub. No.: US 2002/0177663 A1
(43) Pub. Date: Nov. 28, 2002

(54) Composites for railroad ties and other products

(76) Inventor: Paul J. Cahill, Wheaton, IL (US)

Correspondence Address: Welsh & Katz, Ltd., Thomas W. Tolpin, 22nd Floor, 120 South Riverside Plaza, Chicago, IL, 60606, US

(21) Appl. No.: 09/811,250

(22) Filed: Mar. 16, 2001

(51) Int. Cl. C08F 8/00

(52) U.S. Cl. 525/177

(57) ABSTRACT

Formulation of recycled polyethylene terephthalate (PET) with pulverized recycled rubber-like material, and optimally a compatibilizing agent is described for application to railroad tie construction and other products. Desirably, the attractive formulation provides useful products from recycling of plastic PET bottles and discarded tires which greatly benefits the environment. The formulation can be foamed during an extrusion process to reduce the density of the composite so as to be even more economically attractive. Optional use of branching-chain extension agents and/or hydrolytic stabilization additives can also be used in the formulation for further benefits.

### BACKGROUND OF THE INVENTION

This invention relates to composites and products made from disposable plastic bottles of polyethylene terephthalate (PET) and old worn out tires.

In the past, the formulated use of recycled PET in many applications would not be economical because of PET's high material density relative to a polyethylene alternative.

By way of background, solid wastes comprising garbage, combustible and noncombustible rubbish, trash, construction debris, as well as industrial, mining, and agricultural wastes, are usually disposed of in landfills. These landfills generate methane gas from the decomposition of organic wastes which may be explosive unless vented to the atmosphere where it contributes to “green-house” gas accumulation. Incineration, with or without steam/electricity recovery, helps alleviate some of the burden of waste accumulation, but must be accompanied by expensive controls to avoid atmospheric emission of pollutants, such as: oxides of sulfur and nitrogen, fly ash, and unburned solid particulates (residue). Recycling reusable solids, particularly plastic and rubber materials, has been established as one meritorious method of solid waste reduction and environmental enhancement.

The recycling industry has established a recycling code numbered from 1-7 for plastic materials. The higher the number, the more difficult the material is to profitably deploy into useful post consumer applications other than by burning it for energy recovery or for disposal in landfills, which can create environmental problems. Polyesters, specifically polyethylene terephthalate (PET) are afforded the no. 1 recycling code characterization as the most readily recycled plastic manufactured as a commodity. PET is the primary plastic used by the beverage bottle industry. PET bottles are relatively easily collected, separated, and recycled into a multitude of post consumer applications such as fiber, carpeting, bottle, and strapping applications. The no. 2 recycling plastic is high density polyethylene (HDPE) used for manufacturing milk containers as well as for various other packaging applications. Currently, only 20-25% of all plastics manufactured is recycled into useful post consumer products. The major part is landfilled aggravating environmental problems.

The situation within the rubber industry is also grievous. Scrap (discarded) worn-out tires have been estimated to accumulate at a rate of 300 million per year in the USA according to the U.S. Environmental Protection Agency. Furthermore, many areas in the USA ban scrap tires from being disposed in landfills. While some recycling uses are being developed for shredded (crumb) and pulverized rubber such as in asphalt paving and other applications which retards this accumulation of rubber waste, the existing tire dumps pose fire, environmental and mosquito hazards for the communities where they do exist. Hence, it is desirable for more large-scale applications to recycle plastics and rubber materials.

One such potentially large-scale application has been suggested by companies developing railroad cross-ties based upon polyethylene. Wooden railroad ties and wood-based posts have been used since the industrial revolution to anchor steel and iron rails in railway-beds. As untreated wood products rapidly decay in the environment, wooden ties must be made out of hardwood stocks that are heavily creosoted to avoid deterioration by bio-organisms upon exposure to the elements. The creosote compounds used in this process are often environmentally objectionable both at the point of treatment and at the occasion of eventual tie disposal upon replacement, because of concerns of the leaching characteristics for creosote compounds, as well as concerns for associated ground water contamination. Regulations concerning these problems are spurring attempts to devise more environmentally friendly replacements for railroad tie compositions. The hardwood stock used in manufacturing railroad ties is also becoming increasingly scarce as a natural resource. Economically, it is more advantageous to use hardwoods in higher valued applications, such as furniture construction. It is becoming more difficult to justify use of hardwoods in voluminous lower-valued applications, such as railroad ties. Harvesting of trees for this purpose may actually be exacerbating the dense storage of atmospheric carbon dioxide in hardwood form and hence contributing to global warming.

Recent activity has focused on the manufacture of railroad ties and other support beams from recycled plastic materials. U.S. Plastic Lumber (USPL) has described efforts to manufacture such support elements from recycled milk containers which are primarily made of high density polyethylene (HDPE). Rutgers University, has disclosed use of recycled fiberglass composites as stiffening members for recycled polyethylene. North American Technologies Group, Inc. has suggested railroad ties of recycled polyethylene and pulverized rubber. Yet another description of railroad tie fabrication has been suggested by Primix Corp. based upon dispersion of pulverized rubber in polyethylene. The touted advantage of using such recycled material for this purpose is the avoidance of the bio-hazard associated with use of treated wood-based products and an expected longer service life to offset higher costs of synthetic railroad ties. While these developments are relatively new, it remains to be seen if the touted long service life of polyethylene based products can be realized.

It has been reported that there are approximately 10-14 million crossties (railroad ties) replaced in the USA alone per year (against an inventory exceeding 594 million in place). At a conservative weight of 250 lbs per crosstie, that represents an application area capable of absorbing 2.5-3.5 billion pounds of material per year in the USA alone. Since the US PET bottle industry is of the order of 3 billion pounds per year and that market is projected to double in size (an additional 3.0 billion pounds equivalent to 30 billion bottles at 10 bottles/lb), a potential recycling market of this magnitude would appear to be desirable. While the fiber market is large (where about 60% of the recycled PET is presently used), fiber markets could not easily accommodate the recycle of colored bottles because the color is not easily extracted nor desirable for most fabrics. Since railroad ties are usually black or brown, feedstock color of recycled PET bottles would not be considered objectionable for railroad ties. Hence, there is a growing market need for additional uses of recycling PET containers (e.g. bottles).

It is, therefore, desirable to provide improved composites and products which overcome most, if not all, of the preceding problems.

### BRIEF SUMMARY OF THE INVENTION

An improved composition provides superb composites and products which are economical, reliable, and effective. Advantageously, the inventive composition provides improved uses of disposable plastic bottles and enhanced uses of old discarded tires. Desirably, the user-friendly composites and products better comply with environmental regulations and decrease the need for landfills and other waste disposal sites.

The improved composition comprises polyethylene terephthalate (PET) and an elastomeric rubber-like material (elastomeric-containing material). In order to benefit the environment and achieve better uses of waste products, the PET preferably comprises recycled plastic bottles comprising PET and the elastomeric material comprises recycled worn-out tires. The elastomeric material can further comprise ethylene- propylene-diene monomer (EPDM) derived from vehicle wiper blades and door gaskets. Elastomeric material can comprise: styrene-butadiene, polybutadiene, polyisoprene, and/or natural rubber.

In order to further enhance the environment and to provide other attractive uses of waste products, the inventive composition can also comprise polyolefins, such as polyethylene and/or polypropylene. Desirably, the polyolefins are derived from recycled products, such as bottle-based cups, bottle caps, labels, milk jugs, garbage bags, scrap sheeting, plastic bottles, plastic toys, etc.

The composites and products of the invention can also include at least one additive, such as a: foaming agent, compatibilizing agent, chain extending agent (branching agent), hydrolytic resistance agent, and/or filler.

This invention is particularly useful for reformulated use of recycled PET in applications for which it would not be economically chosen because of its high material density relative to a polyethylene alternative. The invention composites are particularly advantageous to produce railroad ties, docking posts, beams for decking and other construction products, such as struts, planks affixed with nails, screws, bolts or hooks, telephone poles, stakes for signage, and other extruded products, as well as, injection molded products, such as shovels, rakes, axes, hammer handles, roof shingles, baseball bats, and cricket bats.

In order to enhance the frictional characteristics of PET, a composite of PET with pulverized rubber from tires is taken as the basic formulation. The rubber can be in the form of powder or dust of less than 20 mesh size, which is readily available within the industry at up to 100 mesh or customized sizings from various tollers and recyclers. These rubber compounds represent noncreeping soft segments in the composite that can have good frictional characteristics with other products, such as hard iron nails. The image of how hard it is to pull a nail from a tire is a good reminder of that characteristic.

Further details of the proposed composite formulation relate to the intimate adhesion of pulverized rubber with the PET matrix polymer. Since there is no intrinsic cohesion between PET and rubber, in order to avoid clumping of the powdered rubber in the molten matrix, it is desirable to add a small quantity of a binder providing a compatibilizer function (e.g. 2-8 wt %) to the two main constituents. Such an envisioned compound could be a material, such as DuPont's Hytrel® thermoplastic elastomer (composed of PBT with partial replacement of the butylene glycol with polytetrahydrofurandiol), or also a copolymer composition derived from PET and polybutadienediol for use in oxygen scavenging technologies. In the latter case, the oxygen scavenging function could desirably be minimized by using antioxidants with the copolymer. This agent comprises both PET and rubber-based substrates which could function well as a compatibilizing agent. A desirable compatibilizing agent used should create good rubber particle adhesion with the hard PET matrix and transfer nail gripping characteristics of the rubber to the composite.

The blending of a low density rubber compound (e.g. ˜1.0 g/cc) can partially offset some of the high density associated with the primary material. For example, a 35% rubber composite (from a tire with a density of about 1.0 g/cc) with PET would result in a 1.23 g/cc composite density (PET at 1.35 g/cc). To further adjust the composite density to approximate that of an analogous polyethylene composite (with rubber), a foaming process can be used in the manufacture of beams by melt extrusion to further reduce its density. Extrusion foaming processes based upon PET are well-known in the processing arts, such as the MuCell® brand microcellular extrusion-molding process described by Trexel Corp. (Woburn, Mass.), or that used by DuPont de Nemours & Company or by BP Amoco Corporation.

Branching agents (chain extending agents) are useful when recycled PET is used as the raw material or with compromised molecular weight and lowered melt viscosity (intrinsic viscosity below 0.6). Such branching agents can provide melt viscosity enhancement, and can be very effective at very low concentrations (e.g. less than 0.5%) at rendering PET feedstock more acceptable for foaming and extrusion.

A hydrolytic resistance (stabilizing) agent can be useful for improving the hydrolytic stability of PET over long periods of time in the outdoors. Such hydrolytic resistance agents can include Stabaxol P100 brand agents [poly(1,3,5-triisopropylphenylene-2,4-carbodiimide)]. Desirably, 2,2′-bis(2-oxazoline) can provide a dual use as a chain extender for recycled PET and improved hydrolytic stability. A correlation can exist between elevated molecular and improved hydrolytic resistance. The use of diimides or bis(2-oxazoline) as hydrolytic resistance agents can lower the level of carboxyl end groups in the polyester chain. Since acidic moieties catalyze the hydrolysis of polyesters, use of one or more of the preceding hydrolytic resistance agents can be useful in products designed for use in either hot or cold, humid or dry outdoor applications.

A more detailed explanation of the invention is provided in the following description and appended claims.

### DETAILED DESCRIPTION OF THE INVENTION

A composition and products and their uses according to the preferred embodiments of the present invention will now be explained.

An improved composition provides environmentally beneficial user-friendly composites and products. The improved composition comprises by weight: 5% to 95% plyethylene terephthalate (PET) with an inherent viscosity (I.V.) of 0.4 to 0.9; and 5% to 50% elastomeric-containing material, such as styrene-butadiene, polybutadiene, polyisoprene, and/or natural rubber.

Preferably, the improved composition comprises by weight: 20% to 80% PET with an inherent viscosity of 0.5 to 0.8; and 10% to 45% elastomeric-containing material with a density of 0.9 to 0.96 g/cc.

Most preferably, the improved composition comprises by weight: 30% to 60% PET with an inherent viscosity of 0.6 to 0.7; and 20% to 40% elastomeric-containing material.

In the illustrative embodiment, the compositions comprise by weight: from 0% to 25% polyolefin comprising polyethylene and/or polypropylene; a compatibilizing agent comprising at least one binder, such as 0% to 6% Hytel-type binder comprising thermoplastic polyester elastomer of polybutylene terephthalate (PBT) and polytetrahydrofuran glycol, from 0% to 3% maleated polyolefin binder of polyethylene and/or polypropylene, or 0% to 1% polyester elastomer binder comprising polybutadienediol (PBD).

The illustrative composition can also comprise 0.05% to 2% of a branching agent providing a chain extending agent, such as: pyromellitic dianhydride, trimellitic anhydride, benzophenonetetracarboxylic acid dianhydride, sulfonyldiphthalic acid dianhydride, 2,2′-bis (2-oxazoline), or pentaerythritol. The improved composition can further comprise from 0% to 3% of a hydrolytic resistance agent, such as: 2,2′-bis (2-oxazoline), poly (1,3,5-triisopropylphenylene-2, 4-carbodiimide, N,N′-bis (2,6-diisopropylphenyl) carbodiimide, and 2,6,2′,6′-tetraisopropyldipheyl carbodiimide. Moreover, the improved composition can also include from 0% to 30% filler comprising additives such as: talc, silica, colorants, glass fibers, carbon black and/or calcium carbonate.

The preferred composition can comprise by weight: from 0% to 15% polyolefin; a compatibilizing agent comprising at least one binder, such as 1% to 5% Hytel-type binder, 1% to 2% maleated polyolefin binder, or 0.1% to 0.8% polyester elastomer binder; from 0.2% to 1% of the preceding branching agents; from 0.2% to 2% of the preceding hydrolytic resistance agents; and from 0% to 25% of the preceding fillers.

Most preferably, the illustrative composition comprises by weight: from 0% to 5% polyolefin; a compatibilizing agent comprising at least one binder, such as 2% to 4% Hytel-type binder, 0.5% to 1.5% maleated polyolefin binder, or 0.3% to 0.6% polyester elastomer binder; 0.3% to 0.6% of the preceding branching agents; 0.5% to 1% of the preceding hydrolytic resistance agents; and 0% to 20% of the preceding fillers.

Preferably, the improved composition for the novel composites and products comprise at least one foaming agent, such as carbon dioxide (CO₂), nitrogen (N₂), argon, cyclopentane, and/or fluorocarbons (partially substituted with chlorine, bromine, or iodine).

TABLE 1
Composite Composition (Wt % of Total)

| | | | | Most |
|---|---|---|---|---|
| Component | | Broad Range | Preferred | Preferred |
| PET | | 5-95% | 20-80% | 30-60% |
| Elastomeric | | 5-50% | 10-45% | 20-40% |
| containing | | | | |
| material | | | | |
| Polyolefin | | 0-25% | 0-15% | 0-5% |
| Foaming Agent¹ | | Density 0.5-1.3¹ | Density 0.80-1.1¹ | Density 0.95- |
| | | | | 1.05¹ |
| Compatibilizing | | | | |
| Agent | | | | |
| a) | Hytrel | 0-6% | 1-5% | 2-4% |
| b) | Maleated | 0-3.0% | 1-2% | 0.5-1.5% |
| | polyolefin | | | |
| c) | PBD cont. | 0-1.0% | 0.1-0.8% | 0.3-0.6% |
| | Polyester² | | | |

| | | | |
|---|---|---|---|
| Branching-Chain | 0.05-2.0% | 0.2-1.0% | 0.3-0.6% |
| Extending Agent | | | |
| Hydrolytic | 0-3.0% | 0.2-2.0% | 0.5-1.0% |
| Resistance Agent | | | |
| Filler³ | 0-30% | 0-25% | 0-20% |

1. Since the foaming agent is preferably an inert gas, it has very little weight and will begin diffusing out of the composite with replacement by air over time. The level of foamed voids is sufficient to lower the density of the composite to the levels indicated. While the foaming agent is preferably 99+% carbon dioxide (due to solubility in PET), it can contain contamination and/or trace levels of other gases such as nitrogen, argon, etc.

2. Based on PBD content of the additive, i.e. copolyester level equals range shown divide by % PBD in copolyester.

3. Filler can be present in the recycled rubber tire component such as carbon black, antioxidant, calcium carbonate, or talc. Glass fiber would be considered as an added filler.

In the case of 2,2′-bis(oxazoline), the additive can be both a chain extender and hydrolytic resistance agent and the amount could be covered by the branching agent usage. In the case of PMDA as a chain extending agent (which increases acidic end group concentration), a hydrolytic resistance agent would be needed.

In order to further enhance the environment and provide even more uses of waste products, the polyolefins preferably comprise recycled products, such as: bottle-base cups, bottle caps, labels, milk jugs, garbage bags, scrap sheeting, plastic bottles, and/or plastic toys.

Advantageously, the inventive composition of the improved composites and products comprise PET derived from recycled PET bottles and elastomeric-containing material comprising granulated or pulverized recycled tires.

The improved composition can further comprise: ethylene-propylene-diene monomer (EPDM) such as derived from vehicle wiper blades or door gaskets and/or seals from vehicles and/or refrigerators.

Advantageously, the improved composition and composites are useful to produce: railroad ties, posts, beams, struts, planks, telephone poles and other poles, stakes, dock supports, decks such as for patios and boats, boat slips, piers, shovels, rakes, ax handles, hammer handles, roof shingles, baseball bats, and cricket bats, as well as other products.

Recycling discarded plastic and rubber into railroad ties (railway crossties) support beams and other products, create a useful function for otherwise burned or landfilled matter and adds economic value. Three dimensional objects, such as railroad ties, support beams, posts, etc. minimize the space-filling characteristics for higher density objects compared to their voluminous low density state as bottles or jugs and tires with high litter potential.

There are many important reasons why the use of PET as a matrix material for railroad tie fabrication is useful. While polyethylene based beams are considered to be adequate for this application and even touted to afford a 60 year useful life, chief concerns relate to the low mechanical modulus of polyethylene, its low glass transition temperature (Tg), and its high coefficient of thermal expansion, all of which could impact the long-term polymer chain creep and relaxation characteristics of the material. Polyethylene characteristics could become detrimental for some products, such as those requiring nail holding characteristics and could deteriorate over time as seasonal expansion and contraction forces exert their influence due to temperature change. High ambient temperature in particular could cause polyethylene to relax an initial tight grip on the rail-holding nails. The elevation of matrix temperature would also be heightened by dispersion of black rubber powder as a heat absorbing entity into the soft matrix during summer time sunlight exposure. A comparison of polyethylene material properties with that of PET is shown in the table below.

TABLE 2
Comparison of Polyethylene and PET

| Property | Polyethylene | PET |
|---|---|---|
| Density (g/cc) | 0.965 | 1.35 |
| Glass Transition Temp. | −85° C. | 75° C. |
| (T_{g}) | | |
| Modulus (kpsi) | 116 | 392 |
| Coefficient of Thermal | 25-32 × 10⁻⁵ | 1.7 × 10⁻⁵ |
| Expansion (20-50° C.) | | |
| Coefficient of friction | 0.6 | 0.45 |
| (film—film) | | |

As shown in Table 2, polyethylene at ambient temperatures could be placed in service at well above the glass transition temperature of the material, reflecting its highly flexible nature in thin film form, such as garbage bags. PET is a stiffer, more slippery material with a high gloss surface. PET's thermal resistance, higher modulus, greater load bearing without deformation, and considerably lower coefficient of thermal expansion render PET less susceptible to daily and seasonal fluctuations in temperature and better suited to retaining its properties over a long time period in comparison to polyethylene. Furthermore, PET as a semi-aromatic substance is less susceptible to atmospheric oxidation than aliphatic polyethylene. Eventual embrittlement and attendant cracking and deterioration of polyethylene can occur unless the polyethylene is well fortified with antioxidants.

In the past, the two main characteristics that would mitigate against use of PET for application to railroad tie fabrication and the like are its high density and lower frictional characterization. The higher density requires more material on a poundage basis to make the same object with an associated economic penalty, and its smooth surface suggests a lower pull-out resistance to nails imbedded in it. One of the many advances of this invention is to overcome the preceding deficiencies, as well as to enhance processing and stability, such as with improved melt viscosity and hydrolytic resistance.

With respect to considering additional uses for recycled PET, there is an emerging beverage industry focus on adapting PET as the bottle construction for oxygen sensitive beverages, such as beer, various fruit-juices, nonrefrigerated and shelf-stable milk, and teas for many of the same reasons that PET has become the standard material of choice in the carbonated soft drink market. The carbonated soft drink market favor PET because of PET's light weight (in comparison to glass containers), nonbreakability, transparency, and gas permeation barrier characteristics (primarily to carbon dioxide). Beverage oxygen sensitivity raises an additional gas barrier issue, and single serve beverage containers add increased importance to gas barrier permeation characteristics, because of increased surface to volume ratio in small sized containers. Use of inner layer barrier materials, such as polyamides, copolyesters or ethylene-vinyl alcohol copolymers, or external and internal bottle coatings for enhanced gas barrier performance can add increased complexity to the recycling separation process. In the case of PET beer bottles, dyes present (either amber or green) further complicate recycling. Should brewers turn to large scale manufacture and sale of their beverages in PET containers in the future, that application could easily increase the size of the PET bottle business, as well as greatly increase disposal problems and environmental concerns. Much of this emerging market is not expected to be filled by a polyolefin based plastic (such as polyethylene, polypropylene, etc.) because the gas barrier, modulus (dimensional creep under pressure) or thermal (pasteurization) requirements are so steep, but would favor polyester-based containers. It is within these market dynamics that this invention is also provided to suggest how PET-based composites can offer many advantages over polyethylene and other existing products.

It is, however, readily acknowledged that material choices for any recycling application would be selected on the basis of cost-minimization and performance-maximization, and that a mix of polymeric types (e.g. polyethylene or PET based-ones) could easily come into play for specialized circumstances (e.g. in localities where thermal properties might become more or less critical). The synthetic wood market is obviously large enough to consider more than one particular solution to specialized circumstances.

Polyethylene Terephthalate Feedstock

Either virgin product of 0.4-0.9 inherent viscosity (I.V.), preferably from 0.5-0.8 I.V., and most preferably from 0.6-0.7 I.V.; recycled polyester containers as flake from reclamation of #1 or PET beverage bottles from 0.4-0.9 I.V., preferably from 0.5-0.8 I.V., and most preferably from 0.60-0.70 I.V. While the lower I.V. feedstocks, e.g. <0.5 I.V. can be used, they would require proportionately greater use of branching agents to modify the melt viscosity of the matrix resin to approximate that of the preferred higher molecular weight feedstock. Inherent viscosity is expressed in deciliters/g (dl/g) and measured in phenol/TCE (60/40) according to ASTM method D2587. PET bearing dyes or barrier layer contamination should not be excluded as raw material.

Elastomeric Feedstock Providing Elastomeric-containing Material

Elastomeric feedstock providing the elastomeric-containing material can comprise granulated, pulverized, recycled tires composed of styrene-butadiene-rubbers, polybutadiene (varying cis-content) rubbers, polyisoprene rubbers, and natural rubber based materials, from original equipment manufacturers (OEM) and other companies, such as from the Firestone, Goodyear, BF Goodrich, Zeon, etc. Densities of these base materials range from 0.90 to 0.96. Dispersed carbon black and other commercial additives such as antioxidants and various fillers are to be found in recycled rubber. Various ethylene-propylene-diene monomer (EPDM) based elastomeric materials from sources, such as wiper blades, door gaskets would also be expected to be found in recycled rubber. Generally, highly pulverized feedstock is to be preferred in this process, consistent with maintaining uniform pressure drops across the die orifice of a foaming process, i.e. powder of 10-200 mesh (0.079-0.0029″), preferably from 20-140 mesh (0.033-0041″), and most preferably from 30-100 mesh (0.023-0.005941 ).

Polyolefin Feedstock

Minor amounts of recycled polyolefins, mainly polyethylene or polypropylene, can be used in the formulation of the composition of the composites and products. Such polyolefins may be derived from recycled bottle base-cups (polyethylene), bottle caps and labels (polypropylene) or as deliberate additions from other sources, such as milk jugs (high density polyethylene), garbage bags, scrap sheeting, or from polyolefin based toys and other plastic bottles. Polyolefins can be either used as distinct raw materials or as contaminants in a crude polyester bale of smashed bottles in the recycle stream in an effort to reduce separation costs.

Foaming Agents

Foaming agents, such as nitrogen (N₂) or preferably carbon dioxide (CO₂) can be useful to efficiently mold the recycled composite products of this invention. In some circumstances, it may be useful to use other foaming agents, such as: argon or volatile hydrocarbons, e.g. cyclopentane or fluorocarbons. Carbon dioxide and the inert gases do not add volatile organic hydrocarbon emissions in the molding or production of the composite products and are accordingly preferred.

Combinations of foaming agents such as use of CO₂ and cyclopentane can be used in some circumstances to achieve more uniform control over the size distribution of voids in the extruded profile from the outer surface to the internal elements of the cross-section of the composite products. If desired, internal voids can be used advantageously in the fabrication of hollow articles.

The amount of foaming agent should be sufficient to lower the composite density to a range to be more economically competitive with a polyethylene based analogous product at minimal sacrifice to the primary mechanical properties of the composite product in the absence of the foaming agent.

Compatibilizing Agents Provide Binders

A compatibilizer for a polymer composite (e.g. mixing A & B elements) is an additive used at low levels that is composed of the two distinct segments of dissimilar and incompatible materials that are being mixed joined together in the same molecule (e.g. an A-B composition or an A′-B′ molecule where association of the respective composite components takes place). The compatibilizing or dispersing agent accordingly tends to associate each end of the molecule with the corresponding material and is hence located at the surface of the dispersed entity or at the interface between the incompatible materials. Cohesion of the dispersed entities is important to gain expected mechanical advantages of the dispersed phases. In the present case, “A” would be polyester (semiaromatic) and “B” would be powdered rubber or recycled polyolefins (either polyethylene or polypropylene), which are aliphatic in character. One specific type of compatibilizing agent for polyesters and polyolefins is maleated polyethylene or polypropylene (usually on the order of 1% maleation).

A thermoplastic polyester elastomer based on polybutylene terephthalate (PBT) and polytetrahydrofuran glycol can be used as a compatibilizing agent, such as available under the brand name of DuPont Hytrel® by DuPont de Neumour & Co. The PBT units would be attracted to PET and the soft amorphous glycol segments can be attracted to dispersed rubber units. A use level of 1.0-5.0 wt % (based upon PET feed) is preferred for this material as a compatibilizing agent.

Also, a copolymer of PET with polybutadienediol (PBD) could be used, such as a polybutadienediol of about 1000-4000 Mₙ, (number average molecular weight). Preferred compositions would comprise diols of 2000-3500 Mₙ, and most preferred compositions would comprise a diol of ca. 2800 Mₙ (such as available by Elf Atochem under the brand name R45HT) at a level of 2-12 wt % in the copolymer. A most preferred level would be from 7-10 wt % of the PBD in PET. Such a copolymer would be used at a composite level of about 6 wt % to afford a PBD content in the composite of about 0.5 wt %. The polybutadienediol can contain antioxidants such as hindered phenols (e.g. 2,6-ditertbutyl-p-cresol, 1,3,5-tris-(3,5-ditertbutyl-4-hydroxybenzyl)-mesitylene, or octadecyl 3-(3,5-diterbutyl-4-hydroxyphenyl)-propionate with or without tris-(nonylphenyl)-phosphite as a synergist at total levels of 0.01-2.0% (based on diol), preferably from 0.1-1.0%, and most preferably from 0.3-0.7 wt % of the polybutadiene used. The compatibilizer can be premade as a copolymer additive by extrusion or be made in-situ by feeding a small quantity of the inhibited polybutadienediol to the foaming extrusion process, so as to afford a level of about 0.5 wt % in the final extrudate depending upon the ratio of rubber powder to PET used in the foamed composite.

Branching-chain Extending Agents

Branching-chain extending agents are additives to the extrusion process that help counteract the normal tendency of polyesters to degrade molecular weight at each melt processing step. The total exclusion of moisture is virtually impossible with polyesters normally predried before use to a level near 50 ppm water content as measured by Karl-Fisher (KF) titrimetric methods or by modem instrumental methods correlating well with the KF analysis. Moisture levels exceeding this level can cause significant and proportionate losses of molecular weight as measured by extrudate I.V. Branching-chain extending additive use can raise the melt viscosity of a moisture degraded substrate, such as encountered with recycled PET, or elevate the melt viscosity of a suitably dried one. Elevated melt viscosity is required for efficient foaming characteristics of any polymeric feed. Examples of branching agents include: pyromellitic dianhydride, trimellitic anhydride, benzophenonetetracarboxylic acid dianhydride, sulfonyldiphthalic acid dianhydride, or pentaerythritol, A preferred branching agent is pyromellitic dianhydride, such as in the range from 0.05-2.0 wt % in the composite.

Use of 2,2′-bis(2-oxazoline) as a chain extender for processing recycled PET is also useful to counter the effects of high acid end group content and moisture in degrading the polyester upon melt processing. This dibase can apparently form salts with the acidic end groups of the polyester so as to extend the polyester chains and also neutralize an acid catalysis of hydrolysis as well. Furthermore, 2,2′-bis(2-oxazoline) can also assist in the compatibilization function with maleated polyolefin to disperse PBT in polypropylene (the inverse compatibilization of limited polyester in polyolofin).

Hydrolytic Resistance Agents

Hydrolytic stability of polyesters has been associated with elevated inherent viscosity (I.V.). Hydrolytic resistance agents can enhance the hydrolytic lifetime of PET products.

Chain extending agents such as 2,2′-bis(2-oxazoline) can function well as both a molecular weight elevator as well as a hydrolytic resistance agent especially as acidic end group content is reduced.

Poly(1,3,5-triisopropylphenylene-2,4)-carbodiimide, used at 0.01-2.0 wt %, preferably from 0.05-1.5 wt %, and most preferably from 0.5-1.0 wt % can be useful as a hydrolytic resistance agent.

N,N′-bis(2,6-diisopropylphenyl)carbodiimide can also be used as a hydrolytic resistance agent.

A terminal blocking agent for improving hydrolytic resistance can be 2,6,2′,6′-tetraisopropyl-diphenyl carbodiimide.

Fillers

Fillers can be used as additives to the formulation of the recycled composite products. Such fillers can comprise: talc, silica, chopped glass fiber reinforcement for modulus enhancement, colorants, carbon black, and calcium carbonate. While wood dust would be desirable as a filler, it is not very compatible with polyester because of its moisture generating character which markedly impacts polyester processability. Fillers can also be added as part of the recycled rubber raw material for the composite. An additional additive can be a colorant to create uniform product coloration, such as diazo condensation Pigment Brown 23. A PET based matrix with such colorants and/or other fillers could accordingly more readily accommodate higher levels of black heat absorbing rubber particles without distortion, deformation or melting due to heat or high temperatures.

Foaming Process

The foaming process can use a twin screw extruder to mix viscous polyester melt including additives, solid (rubber), and gaseous foaming agent phases under a shear environment. The extruder can be configured so as to feed solid as a premix batch on a continuous basis or each solid feed from loss-in-weight feeders. PET can be dried in the conventional manner at 150° C., such as in forced air ovens for at least 4 hours before use to reduce moisture levels to the level of 50 ppm. Rubber powder can also be dried. Chain-extender, compatibilizer, and/or hydrolysis resisting agents can be added as preformed concentrates or as low level additions into the solids hopper of the extruder that is preferably blanketed with dry inert gas (nitrogen) to avoid moisture exposure. The extruder can be configured so as to have a melt seal after the PET is melted by back-flow screw elements just down-stream of PET melting.

In the case of liquid polybutadienediol addition as a compatibilizer, the viscous fluid can be pumped into the extruder barrel over screw mixing elements past the melt seal section. Thereafter, the composite can be conveyed under a foaming gas environment of from 50- 4000 psi (e.g. CO₂) pressure. The greater the degree of density reduction, the higher the pressure.

The foaming action is the result of establishing a thermodynamically unstable solution condition by either rapidly changing the pressure or temperature (or both). An in-line static mixer following addition of foaming agent can be used to effect the dissolution of the gas into the polymer melt mix. The extruder can also be configured to effect a rapid decompression of the solution at the exodus of the melt. For a large scale extrudate, a slit die expanding to the dimensions of the extruded object can be used. The foamed extrudate can be cooled through a heated chamber to achieve crystallization of the extrudate. The extrudate can then be cut in-line into the segments of desired length.

While the dispersion of rubber into PET based synthetic railroad ties should afford compression dampening characteristics to such composites, small-sized gas bubbles as a foamed substrate could also augment such an action. A composite product can also form many nucleating sites for gas bubble formation upon extrusion pressure reduction.

Use of chain extending additives in the foaming process would also tend to enhance the overall hydrolytic resistance of the product in the form of higher molecular weight chains. Chain extending additives can also assist in maintaining a high enough matrix molecular weight that an extruded large volume object, such as a railroad tie, would be able to cool from the melt without cracking. Such stresses can build up when the outside extrudate dimensions become fixed or frozen by cooling first while the internal melt undergoes subsequent crystallization shrinkage as the internal mass elements cool, resulting in extensive cracking below ca. 0.6 I.V. Matrix adhering dispersed rubber can also assist in stress relief upon product cool-down in the extrusion process. Overall, molecular weight control for recycled PET is a factor for any melt fabrication as each thermal process step degrades the feedstock I.V. from 0.05 to 0.1 depending upon the residual moisture content in the 50-100 ppm range.

While a continuous extrusion process is described, it is to be recognized that other variations of a foaming process, such as the use of a batch foaming process, and/or another molding process, could be used within the spirit of this invention.

Furthermore while the preferred process produces a microcellular closed cell (discontinuous voids) composite and products, an open cell construction (semi-continuous voids) can be used in some circumstances for the composite products in order to reduce the density of the composition to an economically attractive level at minimal compromise to the compressive strength characteristics of the composite.

The composites of the invention are particularly useful for railroad ties, docking posts, beams for decking and other construction elements such as struts, or planks affixed with nails, screws, bolts or hooks, telephone poles, or stakes for signage, or injection molded objects such as shovels, rakes, axes, or hammer handles, shingles, or baseball or cricket bats.

While the immediate scope of this invention is directed toward compositions useful for railroad tie applications, it is to be understood that other applications and products can be envisioned by a person skilled in the art, such as compositions for extrusion of synthetic support beams, posts, dock supports and telephone poles, as well as for other composite products.

Among the many advantages of the composites and products of the invention are:

1. Outstanding performance.

2. Superb composites and products.

3. Excellent value.

4. Environmentally attractive.

5. Decreased need for landfills.

6. Superb benefits for the environment.

7. Better uses of old discarded tires.

8. Enhanced uses for disposable plastic bottles.

9. Improved railroad ties and other products.

10. Convenient products which are easy to use and install.

11. Dependable.

12. Safe.

13. Economical.

14. Efficient.

15. Effective.

Although embodiments of this invention have been shown and described, it is to be understood that various modifications, substitutions, and rearrangements of compounds and method steps, as well as other uses of the composites and products of the invention, can be made by those skilled in the art without departing from the novel spirit and scope of this invention.

What is claimed is:

1. A composition, comprising:
polyethylene terephtalate (PET); and
elastomeric material.

2. A composition in accordance with claim 1 wherein said PET comprises recycled plastic bottles comprising PET.

3. A composition in accordance with claim 1 wherein said elastomeric material comprises recycled tires.

4. A composition in accordance with claim 3 wherein said elastomeric material further comprises ethylene-propylene-diene monomer (EPDM) selected from the group consisting of: wiper blades and door gaskets.

5. A composition in accordance with claim 1 wherein said elastomeric material comprises at least one elastomeric selected from the group consisting of: styrene-butadiene, polybutadiene, polyisoprene, and natural rubber.

6. A composition in accordance with claim 1 further comprising polyolefins selected from the group consisting of polyethylene and polypropylene.

7. A composition in accordance with claim 6 wherein said polyolefins comprise recycled products selected from the group consisting of: bottle-base cups, bottle caps, labels, milk jugs, garbage bags, scrap sheeting, plastic bottles, and plastic toys.

8. A composition in accordance with claim 1 including at least one additive selected from the group consisting of: a foaming agent, compatibilizer agent, chain extending agent, hydrolytic resistance agent, and filler.

9. A composition in accordance with claim 1 wherein said composition comprises a product selected from the group consisting of: a railroad tie, post, beam, strut, plank, pole, dock support, deck, boat slip, pier, stake, shovel, rake, ax handle, hammer, handles, shingle, baseball bat, and cricket bat.

10. A composition, comprising by weight:
from about 5% to about 95% polyethylene terephthalate (PET) with an inherent viscosity (I.V.) from about 0.4 to about 0.9; and
from about 5% to about 50% elastomeric-containing material selected from the group consisting of styrene-butadiene, polybutadiene, polyisoprene, and natural rubber.

11. A composition in accordance with claim 10 comprising by weight:
from about 20% to about 80% PET with an inherent viscosity from about 0.5 to about 0.8; and
from about 10% to about 45% elastomeric-containing material with a density from about 0.9 to about 0.96 g/cc.

12. A composition in accordance with claim 10 comprising:
from about 30% to about 60% PET with an inherent viscosity from about 0.6 to about 0.7; and
from about 20% to about 40% elastomeric-containing material.

13. A composition in accordance with claim 10 including at least one foaming agent selected from the group consisting of: carbon dioxide, nitrogen, argon, cyclopentane, and a fluorocarbon partially substituted with chlorine, bromine, or iodine.

14. A composition in accordance with claim 10 comprising by weight:
from about 0% to about 25% polyolefin selected from the group consisting of polyethylene and polypropylene;
a compatibilizing agent comprising at least one binder selected from the group consisting of about 0% to about 6% Hytel-type binder comprising thermoplastic polyester elastomer of polybutylene terephthalate (PBT) and polytetrahydrofusan glycol, from about 0% to about 3% maleated polyolefin binder selected from the group consisting of polyethylene and polypropylene, and from about 0% to about 1% polyester elastomer binder comprising polybutadienediaol (PDS);
from about 0.05% to about 2% of a branching agent providing a chain extending agent selected from the group consisting of pyromellitic dianhydride, trimellitic anhydride, benzophenonetetracarboxylic acid dianhydride, sulfonyldiphthalic acid dianhydride, 2,2-bis(2-oxazoline), and pentaerythritol;
from about 0% to about 3% hydrolytic resistance agent selected from the group consisting of 2,2′-bis(2-oxazoline), poly(1,3,5-triisopropylphenylene-2,4-carbodiimide, N,N′-bis(2,6-disopropylphenyl) carbodiimide, and 2,6,2′,6′-tetraisopropyldipheyl carbodiimide; and
from about 0% to about 30% filler comprising additives selected from the group consisting of talc, silica, colorant, glass fibers, carbon black, and calcium carbonate.

15. A composition in accordance with claim 14 comprising by weight:
from about 0% to about 15% polyolefin;
a compatibilizing agent comprising at least one binder selected from the group consisting of about 1% to about 5% Hytel-type binder, from abut 1% to about 2% maleated polyolefin binder, and from about 0.1% to abut 0.8% polyester elastomer binder;
from about 0.2% to about 1% branching agent;
from about 0.2% to about 2% hydrolytic resistance agent; and
from about 0% to about 25% filler.

16. A composition in accordance with claim 14 comprising by weight:
from about 0% to about 5% polyolefin;
a compatibilizing agent comprising at least one binder selected from the group consisting of about 2% to about 4% Hytel-type binder, from about 0.5% to about 1.5% maleated polyolefin binder, and from about 0.3% to about 0.6% polyester elastomer binder;
from about 0.3% to about 0.6% branching agent;
from about 0.5% to about 1% hydrolytic resistance agent; and
from about 0% to about 20% filler.

17. A composition in accordance with claim 14 wherein said polyolefins comprise recycled products selected from the group consisting of: bottle-base cups, bottle caps, labels, milk jugs, garbage bags, scrap sheeting, plastic bottles, and plastic toys.

18. A composition in accordance with claim 10 wherein:
said PET comprises recycled PET bottles; and
said elastomeric-containing material comprises granulated or pulverized recycled tires.

19. A composition in accordance with claim 18 further comprising ethylene-propylene-diene monomer (EPDM) selected from the group consisting of vehicle wiper blades, door gaskets, vehicle seals, and refrigerator seals.

20. A composition in accordance with claim 10 wherein said composition comprises a product selected from the group consisting of: a railroad tie, post, beam, strut, plank, pole, dock support, deck, boat slip, pier, stake, shovel, rake, ax handle, hammer, handle, shingle, baseball bat, and cricket bat.
